(19) United States
(12) Patent Application Publication
(10) Pub. No.: US 2025/0336998 A1
(43) Pub. Date: Oct. 30, 2025

(54) HIGH ENTROPY ELECTROLYTE MATERIAL, METHOD FOR MANUFACTURING SAME, AND HIGH-PERFORMANCE BIDIRECTIONAL PROTON CONDUCTIVE FUEL CELL USING SAME

(71) Applicant: KOREA ADVANCED INSTITUTE OF SCIENCE AND TECHNOLOGY, Daejeon (KR)

(72) Inventors: Kang Taek LEE, Daejeon (KR); Dong Yeon KIM, Daejeon (KR); Se Eun OH, Daejeon (KR)

(21) Appl. No.: 18/995,591

(22) PCT Filed: Oct. 10, 2024
(86) PCT No.: PCT/KR2024/096310

§ 371 Date: Jan. 16, 2025

(30) Foreign Application Priority Data
Oct. 27, 2023 (KR) 10-2023-0145918
Aug. 12, 2024 (KR) 10-2024-0107849

(51) Int. Cl. H01M 8/1016; C01G 27/00; C01G 33/00; H01M 8/12; H01M 8/1253

(52) U.S. Cl. CPC H01M 8/1016; C01G 27/006; C01G 33/006; H01M 8/1253; C01P 2002/50; C01P 2002/72; C01P 2004/03; C01P 2006/40; H01M 2008/1293; H01M 2300/0074

(57) ABSTRACT

An embodiment may solve the problem of low sinterability of electrolytes of existing high entropy perovskite oxide materials through an electrolyte with improved structural stability of a matter at high temperatures without unnecessary enthalpy change, and provide a bidirectional proton conductive fuel cell with improved proton conductivity and electrochemical performance by using such an electrolyte.

### TECHNICAL FIELD

The present invention relates to a high entropy electrolyte material, a method for manufacturing the same, and a high-performance bidirectional proton conductive fuel cell using the same.

### BACKGROUND ART

As energy consumption continues to increase worldwide, the need to develop efficient and clean energy conversion and storage technologies is increasing.

Among them, hydrogen is considered a promising candidate for reducing carbon dioxide emissions and achieving carbon neutrality. Recently, among energy conversion and storage technologies using hydrogen as fuel, a bidirectional proton conductive fuel cell (PCEC) has been attracting attention. This is a next-generation energy conversion system that can convert hydrogen into electricity in a fuel cell mode and electricity into fuel in an electrolytic cell mode and operates with high efficiency.

Compared to the existing oxygen ion conduction-based solid oxide fuel cell (SOFC), the PCEC has the advantage of easy charge transfer with lower activation energy (0.4-0.6 eV) than oxygen because it uses protons with a small ion radius. Therefore, the PCEC can provide high energy conversion efficiency at lower temperatures (450-650° C.) than the existing solid oxide fuel cell, which is advantageous in the development of low-cost, high-efficiency systems.

However, depending on the type of electrolyte, secondary phase-related performance degradation factors may occur. There is a need to develop a novel electrolyte to suppress these problems.

### DETAILED DESCRIPTION OF THE INVENTION

### Technical Problem

An aspect of the present invention is to provide an electrolyte having high compositional entropy and improved chemical stability by eliminating performance-degrading factors occurring in electrolytes used in conventional PCEC production.

The aspect of the present invention is not limited to that mentioned above, and other aspects not mentioned will be clearly understood by those skilled in the art from the description below.

### Technical Solution

An embodiment of the present invention provides a method for manufacturing a high entropy electrolyte material, including: manufacturing powder by mixing a barium oxide precursor, hafnium oxide (HfO₂), zirconium oxide (ZrO₂), cerium oxide (CeO₂), yttrium oxide (Y₂O₃), ytterbium oxide (Yb₂O₃), and X oxide; and calcining and then pulverizing the powder. At this time, the X is any one selected from Sn, Nb, Gd, or Zn.

In embodiment of the present invention, the barium oxide precursor may be barium carbonate (BaCO₃).

In embodiment of the present invention, the calcining may be performed at 900° C. to 1300° C. for 8 to 12 hours.

In embodiment of the present invention, the calcining and pulverizing may be performed multiple times.

In embodiment of the present invention, the method may further include mixing NiO powder into the pulverized powder, manufacturing the powder into a pellet form, and sintering.

In embodiment of the present invention, the sintering may be performed at 1200° C. to 1700° C. for 4 to 6 hours.

Another embodiment of the present invention provides a high entropy electrolyte material, represented by Chemical Formula 1:

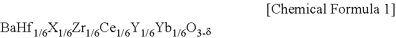

(at this time, the X is any one selected from Sn, Nb, Gd, or Zn).

Another embodiment of the present invention provides a bidirectional proton conductive fuel cell, including a high entropy electrolyte material.

### Advantageous Effects

According to an embodiment of the present invention, it is possible to solve the problem of low sinterability of electrolytes of existing high entropy perovskite oxide materials through an electrolyte with improved structural stability of a matter at high temperatures without unnecessary enthalpy change.

It is possible to provide a bidirectional proton conductive fuel cell with improved proton conductivity and electrochemical performance by using such an electrolyte.

The effects of the present invention are not limited to the effects described above, and should be understood to include all effects that are inferable from the configuration of the present invention described in the detailed description or claims of the present invention.

### BRIEF DESCRIPTION OF THE DRAWINGS

FIG. 1 is an X-ray diffraction pattern of sintered pellet-type high entropy electrolytes (BHNZCYYb, BHSZCYYb, BHZZCYYb, BHGZCYYb).

FIG. 2 is a graph showing the results of measuring ionic conductivity of sintered high entropy electrolytes according to the temperature (650-450° C.).

FIG. 3 is an SEM image showing a microstructure of a unit cell using a high entropy electrolyte.

FIG. 4 is a graph showing chemical stability of a BHSZCYYb electrolyte when exposed to a high-concentration CO₂30% atmosphere at 500° C. for 50 hours.

FIG. 5 includes graphs showing performance of a unit cell using a high entropy electrolyte (BHSZCYYb) in a fuel cell (FC) mode (a) and an electrolytic cell (EC) mode (b).

FIG. 6 is a graph showing stability evaluation when a unit cell was operated for a long time in a fuel cell mode.

FIG. 7 is a graph showing stability evaluation when a unit cell is operated for a long time in an electrolytic cell mode.

### MODE FOR CARRYING OUT THE INVENTION

Hereinafter, the present invention will be described with reference to the accompanying drawings. However, the present invention may be implemented in various different forms, and therefore is not limited to the embodiments described herein. In addition, in order to clearly describe the present invention in the drawings, parts that are not related to the description are omitted, and similar parts are given similar drawing reference numerals throughout the specification. In the entire specification, when a part is said to be “connected (linked, contacted, coupled)” to another part, this includes not only the case where it is “directly connected” but also the case where it is “indirectly connected” with another member in between. In addition, when a part is said to “include” a certain component, this does not mean that other components are excluded unless otherwise specifically stated, but that other components may be additionally provided. The terms used in this specification are used only to describe specific embodiments and are not intended to limit the present invention. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the present invention will be described in detail with reference to the accompanying drawings.

The terms used in this specification are defined as follows.

BHNZCYYb means BaHf_{1/6}Nb_{1/6}Zr_{1/6}Ce_{1/6}Y_{1/6} Yb_{1/6}O₃₋₈.

BHSZCYYb means BaHf_{1/6}Sn_{1/6}Zr_{1/6}Ce_{1/6} Y_{1/6} Yb_{1/6}O₃₋₈.

BHZZCYYb means BaHf_{1/6}Zn_{1/6}Zr_{1/6}Ce_{1/6} Y_{1/6} Yb_{1/6}O₃₋₈.

BHGZCYYb means BaHf_{1/6}Gd_{1/6}Zr_{1/6}Ce_{1/6} Y_{1/6} Yb_{1/6}O₃₋₈.

An embodiment of the present invention provides a method for manufacturing a high entropy electrolyte material, including: manufacturing powder by mixing a barium oxide precursor, hafnium oxide (HfO₂), zirconium oxide (ZrO₂), cerium oxide (CeO₂), yttrium oxide (Y₂O₃), ytterbium oxide (Yb₂O₃), and X oxide; and calcining and then pulverizing the powder. At this time, the X is any one selected from Sn, Nb, Gd, or Zn.

The first is manufacturing powder by mixing a barium oxide precursor, hafnium oxide (HfO₂), zirconium oxide (ZrO₂), cerium oxide (CeO₂), yttrium oxide (Y₂O₃), ytterbium oxide (Yb₂O₃), and X oxide.

The barium oxide precursor may be barium carbonate (BaCO₃).

The matters are weighed in stoichiometric amounts and mixed and pulverized through an ethanol ball milling wet process using a zirconia ball. Thereafter, powder may be obtained through a drying process.

The next is calcining and then pulverizing the powder.

The calcining may be performed at 900° C. to 1300° C. for 8 to 12 hours, and specifically, may be performed at 1100° C. for 10 hours.

Such a wet process and calcining process may be performed once more.

After calcining, a pulverizing process is performed using a planetary ball milling process at 300 rpm for 20 minutes using centrifugal acceleration.

The calcining and pulverizing may be performed multiple times to obtain final powder.

The obtained final powder may be mixed with NiO powder, manufactured into a pellet form, and sintered to manufacture an electrolyte pellet.

The mixing may be performed wet using an acoustic resonance stirrer and ethanol and zirconia balls. The mixed powder may be molded into a pellet form using a single-screw compressor. The sintering of the molded electrolyte pellet may be performed at 1200° C. to 1700° C. for 4 to 6 hours.

Another embodiment of the present invention provides a high entropy electrolyte material represented by Chemical Formula 1.

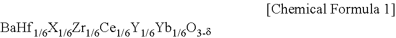

(at this time, the X is any one selected from Sn, Nb, Gd, or Zn).

The high entropy electrolyte material manufactured in this manner is an electrolyte material that solves the low sinterability problem of the existing high entropy perovskite oxide electrolytes through an electrolyte with improved structural stability of a matter at high temperatures without unnecessary enthalpy formation.

Another embodiment of the present invention provides a bidirectional proton conductive fuel cell, including a high entropy electrolyte material.

Using the above-described electrolyte, a bidirectional proton conductive fuel cell with improved proton conductivity and electrochemical performance may be provided.

### Embodiment

1.1 Substance synthesis

BaHf_{1/6}X_{1/6}Zr_{1/6}Ce_{1/6}Y_{1/6} Yb_{1/6}O₃₋₈ (X=Sn, Nb, Gd, Zn, respectively represented by BHSZCYYb, BHNZCYYb, BHGZCYYb, BHZZCYYb) was manufactured through a solid state reaction method. Stoichiometric amounts of Barium carbonate (BaCO₃, Alfa Aesar), Hafnium oxide (HfO₂, Alfa Aesar), Tin oxide (SnO₂, Alfa Aesar), Niobium oxide (Nb₂O₅, Sigma Aldrich), Gadolinium oxide (Gd₂O₃, Alfa Aesar), Zinc oxide (ZnO, Sigma Aldrich), Zirconium oxide (ZrO₂, Alfa Aesar), Cerium oxide (CeO₂, Alfa Aesar), Yttrium oxide (Y₂O₃, Alfa Aesar), and Ytterbium oxide (Yb₂O₃, Alfa Aesar) were weighed and mixed and pulverized using a zirconia ball for 24 hours using an ethanol ball milling wet process. Thereafter, powder obtained through a drying process was calcined at 1100° C. for 10 hours, and a wet process and calcining process were performed once more in the same manner. After calcining, the final powder was obtained by performing a pulverizing process using a planetary ball milling process at 300 rpm for 20 minutes using centrifugal acceleration three times in total.

### 1.2 Electrolyte Pellet Production

Synthesized high entropy electrolyte powder and 1 wt % NiO powder were wet mixed using an acoustic resonance stirrer using ethanol and zirconia balls. The mixed powder was obtained and molded into a pellet form with a diameter of 10 mm using a single-screw compressor at 60 MPa. The molded electrolyte pellet was sintered at 1450° C. for 5 hours to produce a final electrolyte pellet.

### 1.3 Unit Cell Production

A unit cell using a high entropy electrolyte is composed of a fuel electrode support layer, a fuel electrode functional layer, an electrolyte layer, and an air electrode layer. Slurries of the fuel electrode support layer and the fuel electrode functional layer were composed of a NiO and BaZrCeYYbO₃ (BZCYYb) complex and a NiO and high entropy electrolyte (BHSZCYYb) complex, respectively. An electrolyte layer slurry includes a high entropy electrolyte (BHSZCYYb).

The produced fuel electrode support layer, fuel electrode functional layer, and electrolyte layer slurries were produced into fuel electrode support layer, functional layer, and electrolyte layer tapes using a tape casting process. The produced tapes were cut to a size of 8×8 cm², and laminated and pressed at 110° C. in the sequence of the fuel electrode support layer, fuel electrode functional layer, and electrolyte layer.

The pressed tape was cut into a 25 mm diameter circle and then debinding was performed to remove a remaining organic matter through heat treatment at 900° C. for 3 hours. A heat-treated circular substrate was sintered at 1450° C. for 5 minutes using a microwave sintering furnace.

After the microwave sintering was completed, air electrode paste (BaCo_{0.4}Fe_{0.4}Zr_{0.1}Y_{0.1}O_{3-δ}, BCFZY) was applied to the electrolyte layer of the substrate using a screen printing technique and then dried at 90° C. When the air electrode paste was dried, the air electrode layer was sintered at 850° C. for 3 minutes using a microwave sintering furnace to produce a unit cell with lamination of the fuel electrode support layer, fuel electrode functional layer, and electrolyte layer, and the air electrode layer.

### Experimental Example

Crystal structure analysis

A crystal structure of a synthesized high entropy electrolyte powder was analyzed using an X-ray diffraction analyzer (Rigaku, SmartLab). The XRD measurement was performed using Ka radiation (2=1.5418 Å) in the range of 20° to 80°.

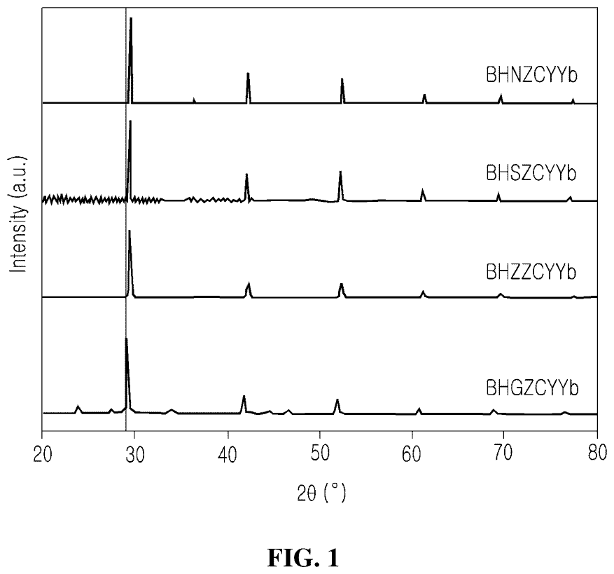

FIG. 1 is an X-ray diffraction pattern of sintered pellet-type high entropy electrolytes (BHNZCYYb, BHSZCYYb, BHZZCYYb, BHGZCYYb).

Referring to FIG. 1, it was confirmed that all four electrolytes form a cubic perovskite phase with high crystallinity. In addition, it was confirmed that the peak corresponding to a 110 plane shifted to the left in the sequence of Gd, Zn, Sn, and Nb, which have larger ionic radii sequentially, thereby increasing lattice constant values (BHGZCYYb: 4.290 Å, BHZZCYYb: 4.282 Å, BHSZCYYb: 4.257 Å, BHNZCYYb: 4.252 Å).
Ionic conductivity evaluation

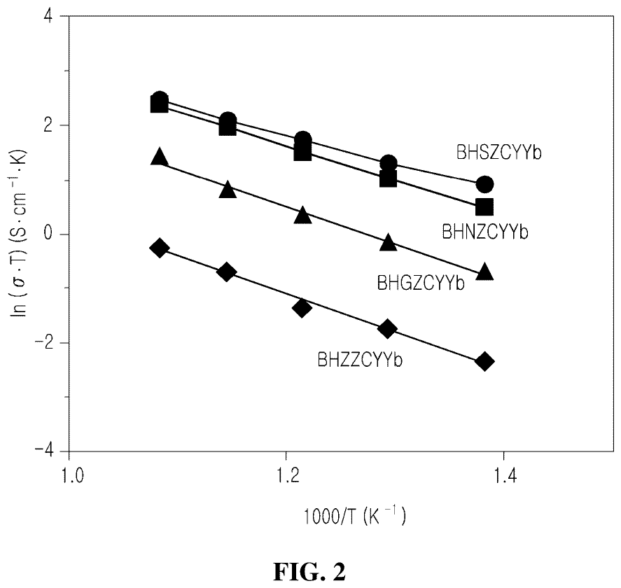

The ionic conductivity of a sintered high entropy electrolyte pellet was measured through electrochemical impedance spectroscopy (EIS), and the evaluation atmosphere was Ar (3% wet). FIG. 2 is a graph showing the results of measuring ionic conductivity of sintered high entropy electrolytes according to the temperature (650-450° C.).

Referring to FIG. 2, BHSZCYYb doped with Sn at the B-site showed high ionic conductivity over the entire temperature range (600° C., 9.2 mS cm⁻¹), and the activation energy required for ionic conduction calculated from the slope was confirmed to be 0.49 eV.
Unit cell microstructure analysis

The microstructure form of a produced unit cell was analyzed using scanning electron microscopy (SEM, Hitachi SU8230).

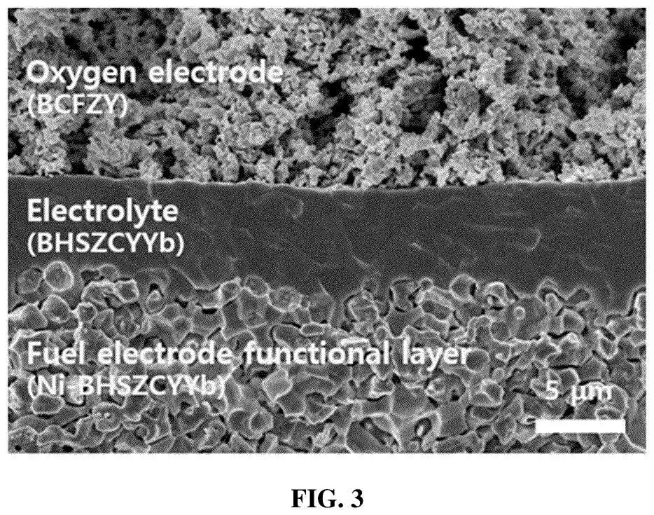

FIG. 3 is an SEM image showing a microstructure of a unit cell using a high entropy electrolyte. Referring to FIG. 3, a unit cell is composed of an air electrode, an electrolyte, and a fuel electrode, and a fuel electrode layer is a fuel electrode functional layer composed of a complex of NiO and BHSZCYYb. It was confirmed that a high entropy electrolyte layer has a thin and dense structure with a thickness of 5 μm, and was bonded without delamination at the interface between the air electrode and the electrolyte, and between the electrolyte and the fuel electrode functional layer.
Chemical stability evaluation

The chemical stability of a high entropy electrolyte (BHSZCYYb) at 600° C. was evaluated by examining the formation of a secondary phase after exposure to a high-concentration CO₂ atmosphere (30% CO₂, 70% Ar) for 50 hours.

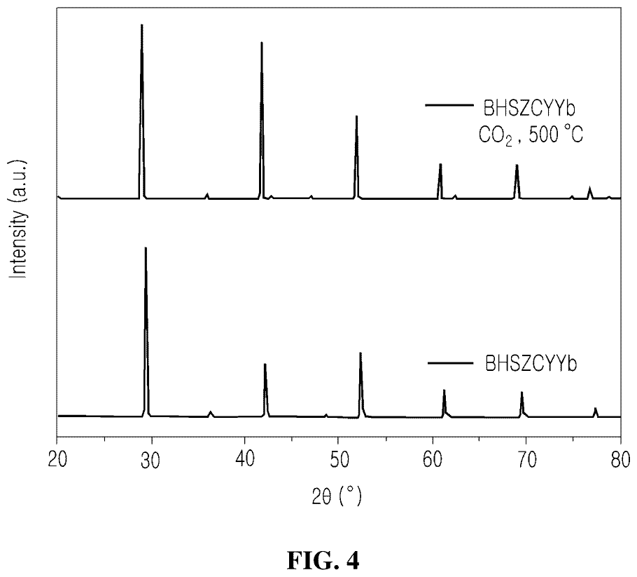

FIG. 4 is a graph showing chemical stability of a BHSZCYYb electrolyte when exposed to a high-concentration CO₂ 30% atmosphere at 500° C. for 50 hours.

Referring to FIG. 4, it was confirmed that BHSZCYYb maintained a stable phase without the formation of a secondary phase even after 50 hours of exposure.
Electrochemical characteristics evaluation

The electrochemical characteristics of a bidirectional unit cell including high entropy were evaluated using a potentiostat (Bio-Logic, VMP-300), and at this time, hydrogen (3% H₂O) and air (3% H₂O) were supplied to a fuel electrode and an air electrode, respectively.

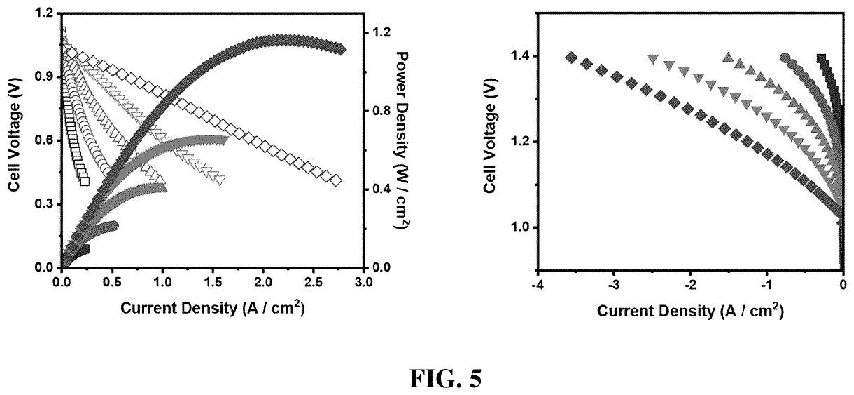

FIG. 5 includes graphs showing performance of a unit cell using a high entropy electrolyte (BHSZCYYb) in a fuel cell (FC) mode (a) and an electrolytic cell (EC) mode (b).

Referring to FIG. 5, it was confirmed that in a fuel cell mode, the power density was 1.15, 0.72, 0.43, 0.25, and 0.11 W cm⁻² at 650° C., 600° C., 550° C., 500° C., and 450° C., respectively, and in an electrolytic cell mode, the current density performance was 2.33, 1.37, 0.71, 0.30, and 0.10 A cm⁻², respectively.

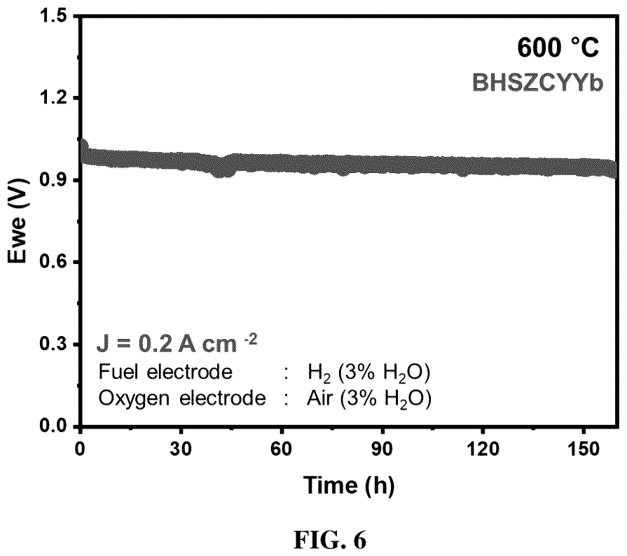

FIG. 6 is a graph showing stability evaluation when a unit cell was operated for a long time in a fuel cell mode.

Referring to FIG. 6, it was confirmed that performance of a unit cell was not significantly reduced when operated at 600° C. for 150 hours or more.

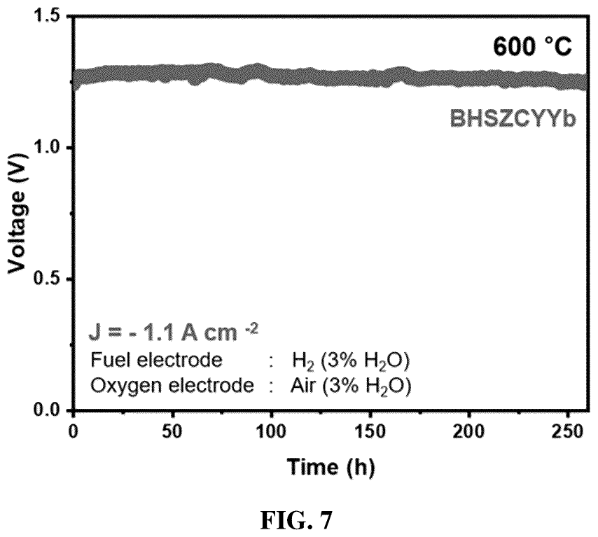

FIG. 7 is a graph showing stability evaluation when a unit cell is operated for a long time in an electrolytic cell mode.

Referring to FIG. 7, it was confirmed that performance of a unit cell was maintained without degradation when operated at 600° C. for 250 hours.

The description of the present invention is for illustrative purposes, and those skilled in the art will understand that it can be easily modified into other specific forms without changing the technical idea or essential features of the present invention. Therefore, the examples described above should be understood as being exemplary in all respects and not limiting. For example, each component described as a single type may be implemented in a distributed manner, and likewise, components described as distributed may be implemented in a combined form.

The scope of the present invention is indicated by the following claims, and all changes or modifications derived from the meaning and scope of the claims and their equivalent concepts should be interpreted as being included in the scope of the present invention.

1. A method for manufacturing a high entropy electrolyte material, comprising:
manufacturing a powder by mixing a barium oxide precursor, hafnium oxide (HfO₂), zirconium oxide (ZrO₂), cerium oxide (CeO₂), yttrium oxide (Y₂O₃), ytterbium oxide (Yb₂O₃), and X oxide; and
calcining and pulverizing the powder,
wherein the X is one selected from Sn, Nb, Gd, or Zn.

2. The method for manufacturing the high entropy electrolyte material according to claim 1, wherein the barium oxide precursor is barium carbonate (BaCO₃).

3. The method for manufacturing the high entropy electrolyte material according to claim 1, wherein the calcining is performed at a range of 900° C. to 1300° C. for 8 to 12 hours.

4. The method for manufacturing the high entropy electrolyte material according to claim 1, wherein the calcining and the pulverizing are performed multiple times.

5. The method for manufacturing the high entropy electrolyte material according to claim 1, further comprising mixing NiO powder into the pulverized powder, manufacturing the powder into a pellet form, and sintering.

6. The method for manufacturing the high entropy electrolyte material according to claim 5, wherein the sintering is performed at a range of 1200° C. to 1700° C. for 4 to 6 hours.

7. A high entropy electrolyte material, represented by Chemical Formula 1: 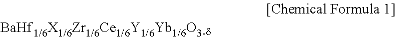
wherein the X is any one selected from Sn, Nb, Gd, or Zn.

8. A bidirectional proton conductive fuel cell, comprising the high entropy electrolyte material of claim 7.
